(19) United States
(12) Patent Application Publication
(10) Pub. No.: US 2015/0012362 A1
(43) Pub. Date: Jan. 8, 2015

(54) SYSTEMS AND METHODS FOR RECOMMENDING PRODUCTS VIA CROWDSOURCING AND DETECTING USER CHARACTERISTICS

(71) Applicant: Jonathan Coon, Austin, TX (US)

(72) Inventor: Jonathan Coon, Austin, TX (US)

(73) Assignee: 1-800 CONTACTS, INC., Draper, UT (US)

(21) Appl. No.: 13/935,338

(22) Filed: Jul. 3, 2013

(51) Int. Cl. G06Q 30/02

(52) U.S. Cl. CPC G06Q 30/0269
USPC 705/14.66

(57) ABSTRACT

A computer-implemented method for recommending products based on crowdsourcing and detecting user characteristics. A characteristic of a first user is detected from an image of the first user. A plurality of products are ranked based on crowdsourced data received for a plurality of images depicting the first user in relation to the plurality of products. One or more relatively higher ranked products from the ranking of the plurality of products are associated with the detected characteristic of the first user.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computers have opened up an entire industry of internet shopping. In many ways, online shopping has changed the way consumers purchase products. For example, a consumer may want to see recommended products and know what they will look like in and/or with those products. On the webpage of a certain product, a photograph of a model with a single particular product may be shown. However, users may want to see more accurate depictions of themselves in relation to various products.

### SUMMARY

According to at least one embodiment, a computer-implemented method for recommending products based on crowdsourcing and detecting user characteristics is described. A characteristic of a first user may be detected from an image of the first user. A plurality of products may be ranked based on crowdsourced data received for a plurality of images depicting the first user in relation to the plurality of products. One or more relatively higher ranked products from the ranking of the plurality of products may be associated with the detected characteristic of the first user. The association between the rankings of the plurality of products and the detected characteristic of the first user may be stored in a repository.

In one embodiment, a characteristic of a second user may be detected from an image of the second user. The characteristic of the first user may be compared to the characteristic of the second user. Upon determining a match exists between the characteristics of the first and second users, a product may be recommended to the second user based on the association between the one or more relatively higher ranked products and the matching detected characteristic of the first user.

In one embodiment, the plurality of images or a link to the plurality of images may be distributed to a plurality of users. A voting mechanism may be displayed in relation to the plurality of images and votes for each of the plurality of images may be collected as part of the crowdsourced data.

In one embodiment, a list of products may be generated and the one or more relatively higher ranked products may be placed towards the top of the list. A notification may be generated indicating a result of the crowdsourced data and the notification may be sent to the first user.

A computing device configured to recommend products based on crowdsourcing and detecting user characteristics is also described. The device may include a processor and memory in electronic communication with the processor. The memory may store instructions that may be executable by the processor to detect a characteristic of a first user from an image of the first user, rank a plurality of products based on crowdsourced data received for a plurality of images depicting the first user in relation to the plurality of products, and associate one or more relatively higher ranked products from the ranking of the plurality of products to the detected characteristic of the first user.

A computer-program product to recommend products based on crowdsourcing and detecting user characteristics is also described. The computer-program product may include a non-transitory computer-readable medium that stores instructions. The instructions may be executable by the processor to detect a characteristic of a first user from an image of the first user, rank a plurality of products based on crowdsourced data received for a plurality of images depicting the first user in relation to the plurality of products, associate one or more relatively higher ranked products from the ranking of the plurality of products to the detected characteristic of the first user.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a crowdsourcing module;

FIG. 4 is a block diagram illustrating one example of a ranking module;

FIG. 5 is a block diagram illustrating one example of a matching module;

FIG. 6 illustrates an example of an image of a user;

FIG. 7 illustrates an example of a collection of images of a user with different products;

FIG. 8 illustrates an example of a database entry;

FIG. 9 is a flow diagram illustrating one embodiment of a method for recommending products based on crowdsourcing and detecting user characteristics;

FIG. 10 is a flow diagram illustrating one embodiment of a method for recommending a product to a current user based on crowdsourcing data related to a prior user;

FIG. 11 is a flow diagram illustrating one embodiment of a method for notifying a user of the results of gathering crowdsourcing data; and

FIG. 12 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to recommending products to users based on crowdsourced data and detected user characteristics. Specifically, the systems and methods described herein relate to a system and method for obtaining a scan of a first user (from, for example, a camera or a video camera, etc.) and detecting characteristics of the user (e.g., hair color, skin color, eye color, size and/or shape of a part of the user such as the head, parts of the face, and other parts of the user, and the like). With the detected characteristics, the user or any number of third parties may be shown images of the user with various products. For example, the user or a third party may be shown multiple, side-by-side images of the user wearing various products (e.g., glasses, hats, scarves, purses, accessories, jewelry, etc.). The side-by-side, comparison images may be distributed for other users to view (e.g., email, text message, instant message, a web site post, a post on TWITTER®, a post on FACEBOOK®, and the like). The system may include a voting mechanism that may be sent with the comparison images to allow users to vote on one or more of their favorite images (e.g., a software application that allows a user to select and/or rank images). Additionally, or alternatively, a link to the comparison images may be distributed. The user may allow the images to be distributed in order to receive feedback on which products look best on the user. In other words, the user may seek a crowdsourced opinion on which products look best on the user. The votes (i.e., crowdsourced data) may be collected and tallied in order to determine which of the products look best on the user. The system may notify the user of the results of the voting. Additionally, or alternatively, the system may associate the top products with one or more detected characteristics of the user. For example, if the images depicted a user wearing different styles of sunglasses, one or more of the top-rated sunglasses may be associated with a characteristic of the user such as the size and shape of the user's head. The system may store associations between top-rated products and user characteristics in a database. When the system obtains a scan of another user, the system may detect one or more characteristics of the other user. The system may compare the detected characteristics of the other user to the user characteristics stored in the database. Upon determining at least one characteristic of the other user matches a characteristic stored in the database, the system may identify one or more products associated with that stored characteristic. The system may then recommend to the other user products based on the matching characteristics and products associated with that matching characteristic.

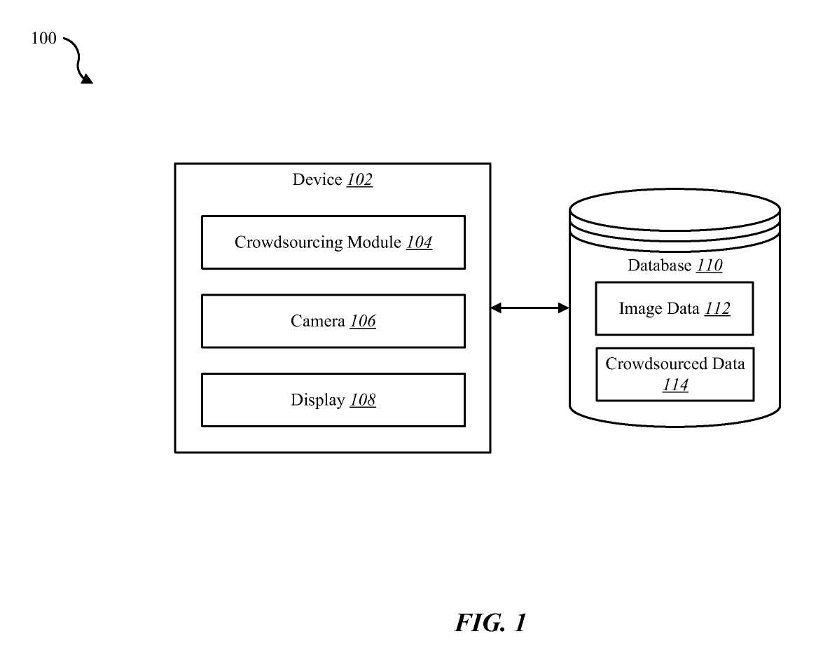

FIG. 1 is a block diagram illustrating one embodiment of an environment 100 in which the present systems and methods may be implemented. In some embodiments, the systems and methods described herein may be performed on a single device (e.g., device 102). For example, a crowdsourcing module 104 may be located on the device 102. Examples of devices 102 include mobile devices, smart phones, tablet computing devices, personal computing devices, computers, servers, etc.

In some configurations, a device 102 may include a crowdsourcing module 104, a camera 106, and a display 108. In one example, the device 102 may be coupled to a database 110. In one embodiment, the database 110 may be internal to the device 102. In another embodiment, the database 110 may be external to the device 102. In some configurations, the database 110 may include image data 112 and crowdsourced data 114.

In one embodiment, among various operations the crowdsourcing module 104 may at least enable the detection of user characteristics, the generation of virtual depictions of a user with one or more products, the collection of crowdsourced data as to how the user looks with regards to the one or more products, and the recommendation of products to other users based on top-rated products and detected user characteristics.

The image data 112 stored in database 110 may include data related to users and or products. In one configuration, image data 112 may include characteristics of users detected from one or more images of the user. For example, the user may capture an image of the user's head using camera 106. The crowdsourcing module 104 may detect one or more characteristics from an image of the user (e.g., skin color, eye color, hair color, size and shape of at least a portion of the user, such as the size and shape of the user's head). The image data 112 may include both the images of the user as well as the detected characteristics. The crowdsourcing module 104 may associated the detected characteristics with one or more products. Thus, image data 112 may include images of the user, images of products, characteristics detected from an image of the user, and/or associations between detected characteristics of the user and various products.

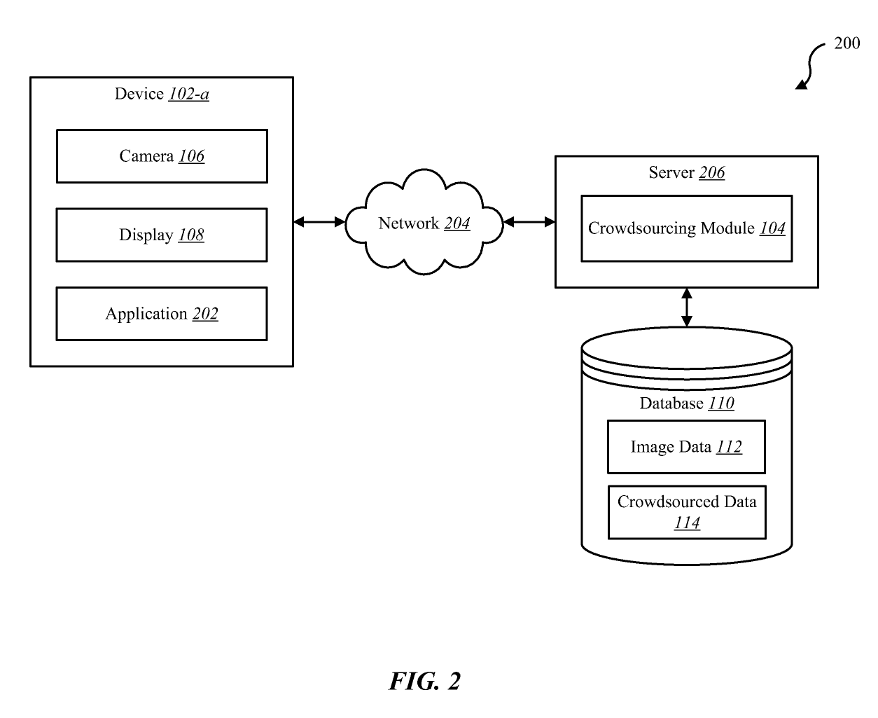

The crowdsourcing module 104 may virtually depict the user in relation to two or more products (e.g., the user virtually depicted wearing multiple styles of sunglasses). The crowdsourcing module 104 may allow one or more other users to vote on which of the depicted products looks best with the user. The crowdsourcing module 104 may collect this data. In one embodiment, the database 110 stores the data as crowdsourced data 114. Further details of the crowdsourcing module 104 are described below in relation to at least FIGS. 2-5 below.

FIG. 2 is a block diagram illustrating another embodiment of an environment 200 in which the present systems and methods may be implemented. In some embodiments, a device 102-a may communicate with a server 206 via a network 204. Example of networks 204 include, local area networks (LAN), wide area networks (WAN), virtual private networks (VPN), wireless networks (using 802.11, for example), cellular networks (using 3G and/or LTE, for example), etc. In some configurations, the network 204 may include the internet. In some configurations, the device 102-a may be one example of the device 102 illustrated in FIG. 1. For example, the device 102-a may include the camera 106, the display 108, and an application 202. It is noted that in some embodiments, the device 102-a may not include a crowdsourcing module 104. In some embodiments, both a device 102-a and a server 206 may include a crowdsourcing module 104 where at least a portion of the functions of the crowdsourcing module 104 are performed separately and/or concurrently on both the device 102-a and the server 206.

In some embodiments, the server 206 may include the crowdsourcing module 104 and may be coupled to the database 110. The database 110 may be internal or external to the server 206. In some embodiments, the database 110 may be accessible by the device 102-a and/or the server 206 over the network 204. For example, the application 202 may access the image data 112 and the crowdsourced data 114 in the database 110 via the server 206.

In some configurations, the application 202 may capture multiple images via the camera 106 and store the multiple images as part of image data 112. For example, the application 202 may use the camera 106 to capture a video. Upon capturing the multiple images, the application 202 may process the multiple images to generate image data 112. In some embodiments, the application 202 may transmit one or more images to the server 206. Additionally, or alternatively, the application 202 may transmit to and/or receive from the server 206 image data 112 and/or crowdsourced data 114 or at least one file associated with image data 112 and/or crowdsourced data 114.

In some configurations, the crowdsourcing module 104 may process multiple images of a user to detect features in an image. In some embodiments, the application 202 may process one or more image captured by the camera 106 in order to detect user characteristics.

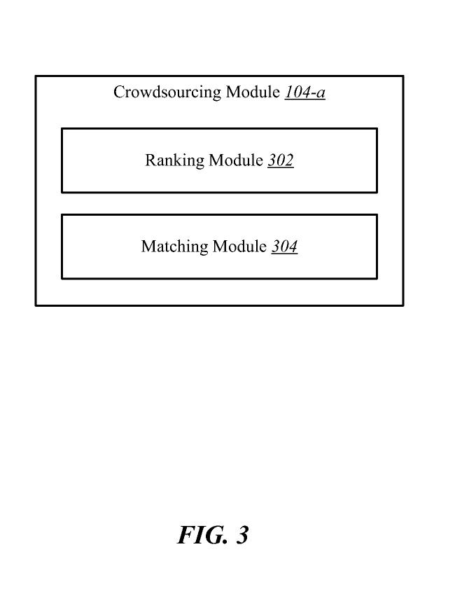

FIG. 3 is a block diagram illustrating one example of a crowdsourcing module 104-a. The crowdsourcing module 104-a may be one example of the crowdsourcing module 104 depicted in FIGS. 1 and/or 2. As depicted, the crowdsourcing module 104-a may include a ranking module 302 and a matching module 304.

In one embodiment, the ranking module 302 may rank a plurality of products based on crowdsourced data 114 received for multiple images depicting the first user in relation to various products. In some configurations, the ranking module 302 may enable the distribution of virtual depictions of the user with various products (i.e., user-product combinations) that allow other users to vote on their favorite user-product combinations. As described above, the votes may be stored as crowdsourced data 114 in database 110. In one embodiment, the ranking module 302 may generate a list of products and place the top-rated products, as determined by crowdsourced data 114, towards the top of the list.

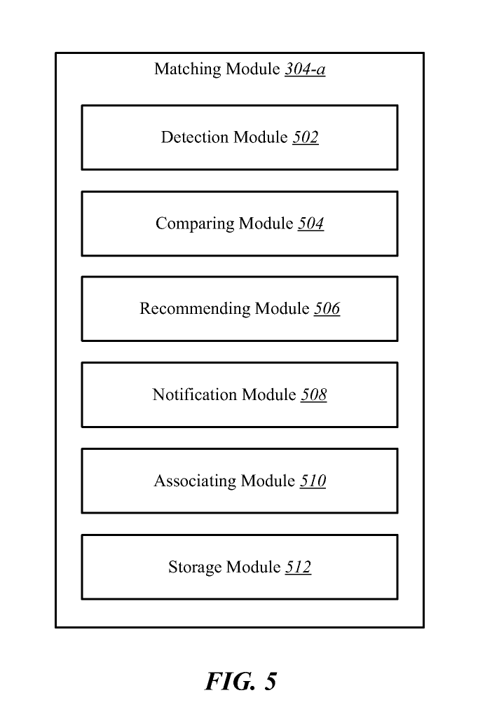

In some embodiments, the matching module 304 may recommend products to a user based on characteristics of the user detected from an image of the user. The matching module 304 may match the detected characteristics of the user to characteristics previously associated with top-rated products. Further details regarding the matching module 304 are described below in relation to FIG. 5.

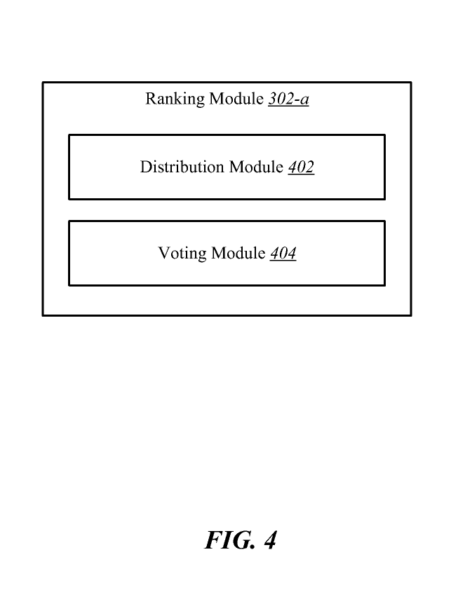

FIG. 4 is a block diagram illustrating one example of a ranking module 302-a. The ranking module 302-a may be one example of the ranking module 302 illustrated in FIG. 3. As depicted, the ranking module 302 may include a distribution module 402 and a voting module 404.

The distribution module 402 may enable one or more user to vote on their favorite user-product combinations. In one embodiment, distribution module 402 may distribute comparison images or a link to comparison images to multiple users. In some embodiments, the voting module 404 may display a voting mechanism in relation to the comparison images to allow the multiple users to vote on their favorite user-product combination. The voting module 404 may collect the votes for each of the comparison images and tally the votes to determine the top-rated products for the user, which data may make up at least a part of crowdsourced data 114.

FIG. 5 is a block diagram illustrating one example of a matching module 304-a. The matching module 304-a may be one example of the matching module 304 illustrated in FIG. 3. As depicted, the matching module 304-a may include a detection module 502, a comparing module 504, a recommending module 506, a notification module 508, an associating module 510, and a storage module 512.

In one embodiment, the detection module 502 may detect characteristics of first and second users from one or more images of the first and second users. In some embodiments, the associating module 510 may associate top-rated products from the ranking of the user-product combinations to the detected characteristic of the user.

In some embodiments, the comparing module 504 may compare a characteristic of the first user to a characteristic of the second user. Upon determining a match exists between the characteristics of the first and second users, the recommending module 506 may recommend a product to the second user based on the association between the one or more relatively higher ranked products and the detected characteristic of the first user. In some embodiments, the storage module 512 may store the association between the rankings of the plurality of products and the detected characteristic of the first user. The notification module 508 may generate a notification indicating a result of the crowdsourced data and send the notification to a user. Thus, the matching module 304-a enables a system to notify a user of the results of requesting a crowdsourced opinion as to which products look best with and/or on the user. The matching module 304-a also enables a system to associate detected characteristics of the user with those products that rated highest in the results of the crowdsourced opinion in order to recommend the top-rated products to other users with similar detected characteristics.

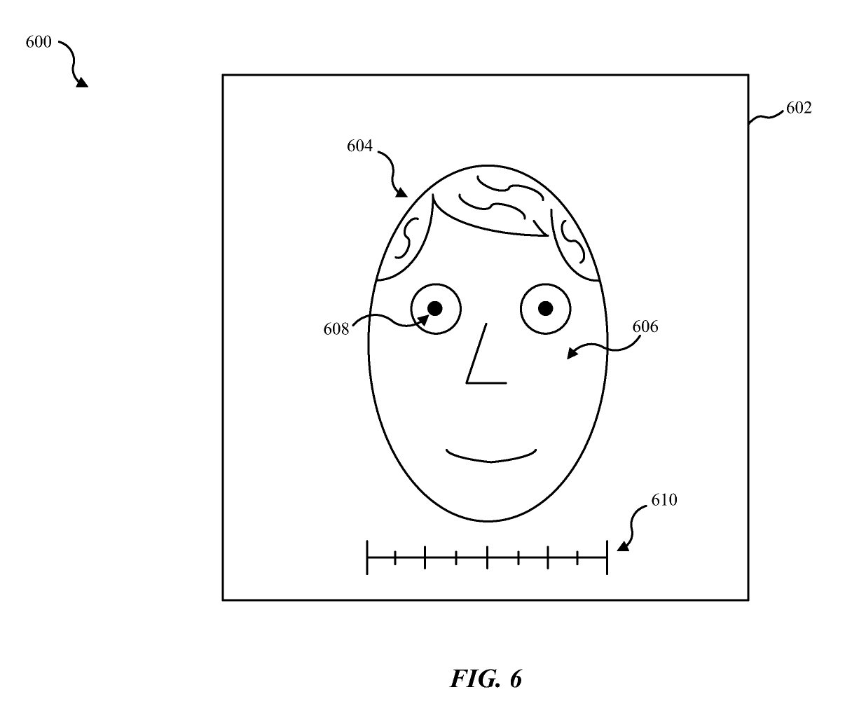

FIG. 6 illustrates an example depiction 600 of an image of a user. As depicted, the example depiction 600 may include an image of a user 602. A device 102 may obtain an image of a user via the camera 106. As described above, the crowdsourcing module 104 may determine certain characteristics of the user from the image of the user 602. For example, the crowdsourcing module 104 may determine a hair color 604, a skin color 606, and the eye color 608 of the user. Additionally, or alternatively, the crowdsourcing module 104 may determine a scale associated with the depicted portion of the user such as the head size 610 of the user and/or the shape of the user's head. The crowdsourcing module 104 may store the detected characteristics in association with top-rated products as image data 112 in database 110. Although the exemplary image of the user 602 depicts the head of a user, it is understood that characteristics of the user may be detected from an image of any portion of the user such as a hand, foot, arm, leg, torso, full body, etc.

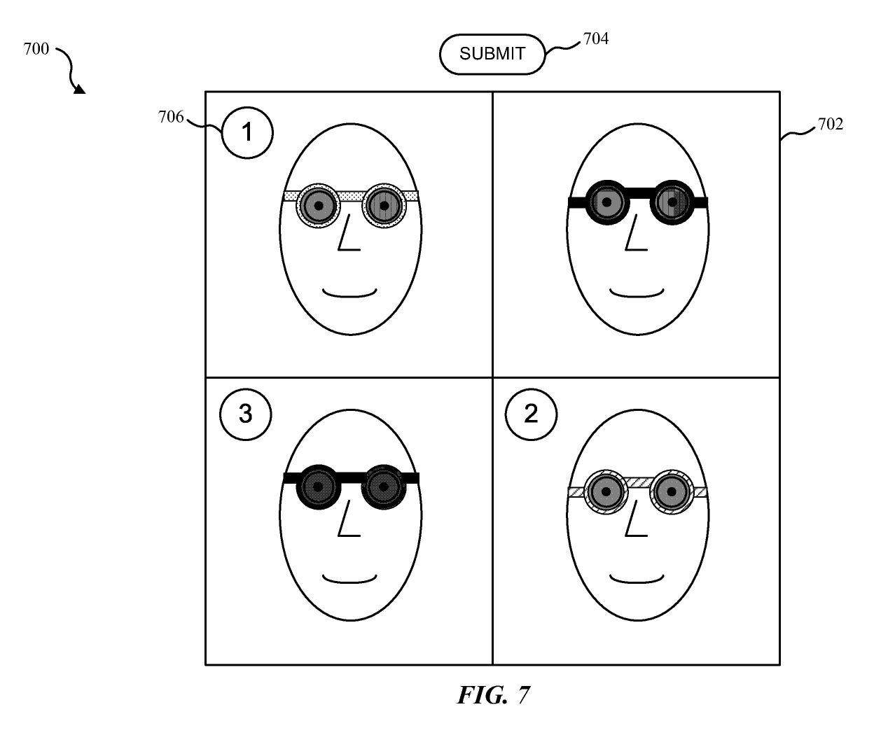

FIG. 7 illustrates an example arrangement 700 of a collection of images of a user in relation to different products. As depicted, the example arrangement 700 may include a collection of comparison images 702. The collection of comparison images 702 may include two or more images of a user with a various products (i.e., user-product combinations). For example, as depicted, the collection of comparison images 702 may include four images of the user wearing four different pairs of sunglasses. Additionally, example arrangement 700 may include various user-interface controls. For example, as depicted, example arrangement 700 may include one or more buttons to allow a user to interact with the collection of comparison images 702, such as a submit button 704. In one configuration, the example arrangement 700 may include a voting mechanism that allows a user to generate a ranking 706 of the collection of comparison images 702. In one embodiment, the voting mechanism may allow a user to touch or click on one of the user-product combinations to vote. For example, the first user-product combination a user touches or clicks on may be ranked as the first favorite image, the second user-product combination a user touches or clicks on may be ranked as the second favorite image, and so forth. As depicted in example arrangement 700, a user may select the top-left image as the first favorite, the bottom-right image as the second, the bottom-left image as the third favorite, and leave the top-right image with no vote. Additional buttons and/or mechanism may be employed in order to enable a user to vote on one or more favorite images of user-product combinations. When the user finishes generating the ranking 706 (where the user selects at least one of the images as a favorite), the user may submit their selection by clicking on the submit button 704.

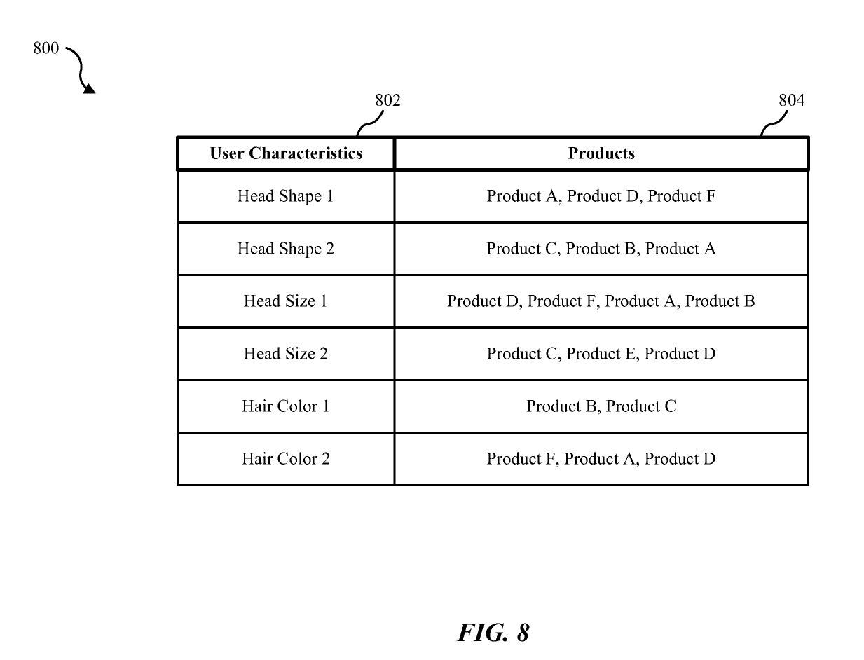

FIG. 8 illustrates an example of a database entry 800. In one embodiment, the database entry 800 is stored in database 110 as part of image data 112. As depicted, the database entry 800 includes at least two columns, a user characteristics column 802 and a products column 804. Although the database entry 800 is depicted as having columns, it is understood that the underlying data of database entry 800 may be arranged using any suitable layout.

In one embodiment, database entry 800 includes an association between at least one user characteristic from the user characteristics column 802 and at least one product from the products column 804. For example, the depicted characteristic head shape 1 may be associated with products A, D, and F. In one embodiment, the products of products column 804 are listed in order of popularity (i.e., for the one or more users with head shape 1, most users voted for product A, then product D, and then product F). As described above, crowdsourcing module 104 may detect a characteristic of a user, query database entry 800 to determine whether the detected characteristic matches one of the characteristics of user characteristics column 802, and upon identifying a match, may recommend products to the user according to the products associated with that matching characteristic. For example, if the shape of the user's head is determined to have the characteristics of head shape 1, then crowdsourcing module 104 may recommend products A, D, and F to the user. Thus, the crowdsourcing module 104 may collect the votes from several users and use the results to notify the user of the top-rated products, associate the top-products with characteristics of the user, and recommend top-rated products to other users based on the other users having similar characteristics.

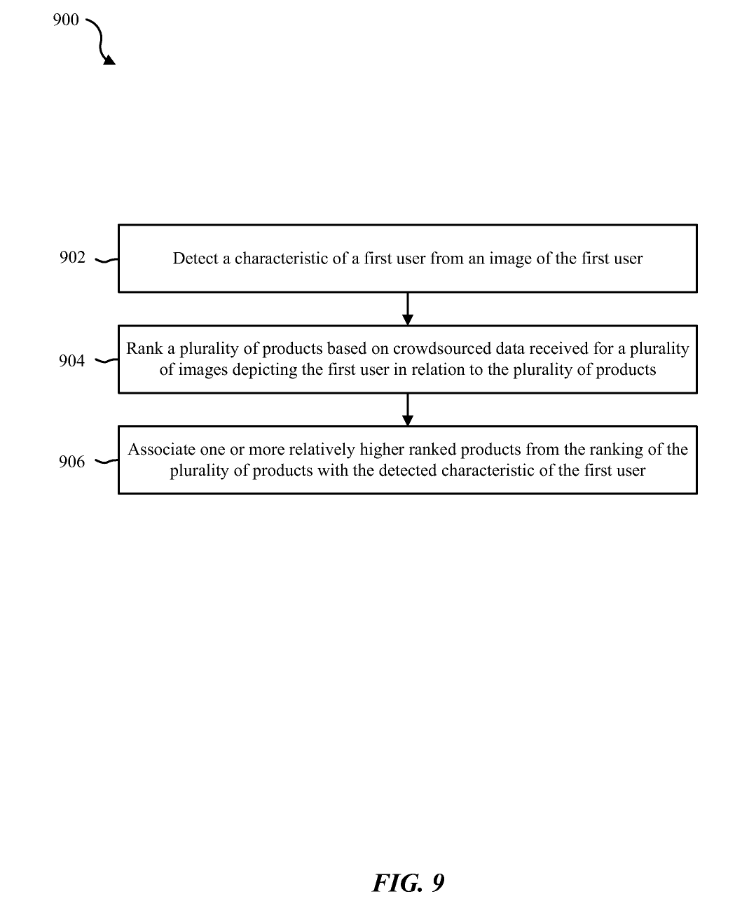

FIG. 9 is a flow diagram illustrating one embodiment of a method 900 for recommending products based on crowdsourcing and detecting user characteristics. In some configurations, the method 900 may be implemented by the crowdsourcing module 104 illustrated in FIGS. 1, 2, and/or 3. In some configurations, the method 900 may be implemented by the application 202 illustrated in FIG. 2.

At block 902, a characteristic of a first user may be detected from an image of the first user. At block 904, a plurality of products may be ranked based on crowdsourced data received for a plurality of images depicting the first user in relation to the plurality of products. At block 906, one or more relatively higher ranked products from the ranking of the plurality of products may be associated with the detected characteristic of the first user.

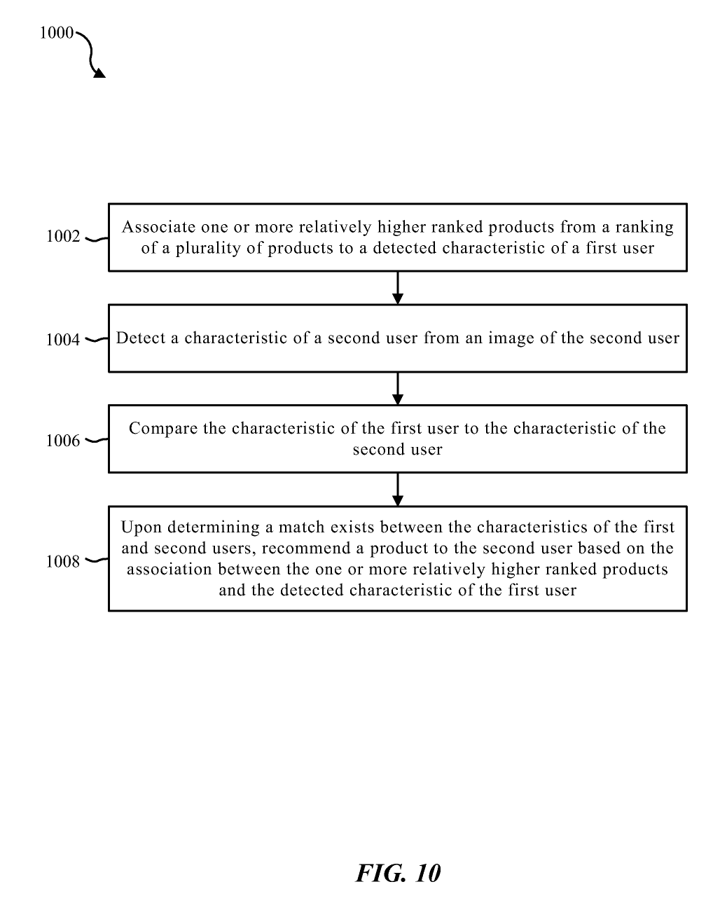

FIG. 10 is a flow diagram illustrating one embodiment of a method 1000 for recommending a product to a current user based on crowdsourcing data related to a prior user. In some configurations, the method 1000 may be implemented by the crowdsourcing module 104 illustrated in FIGS. 1, 2, and/or 3. In some configurations, the method 1000 may be implemented by the application 202 illustrated in FIG. 2.

At block 1002, one or more relatively higher ranked products from the ranking of the plurality of products may be associated with the detected characteristic of the first user. At block 1004, a characteristic of a second user may be detected from an image of the second user. At block 1006, the characteristic of the first user may be compared to the characteristic of the second user. At block 1008, upon determining a match exists between the characteristics of the first and second users, a product may be recommended to the second user based on the association between the one or more relatively higher ranked products and the matching detected characteristic of the first user.

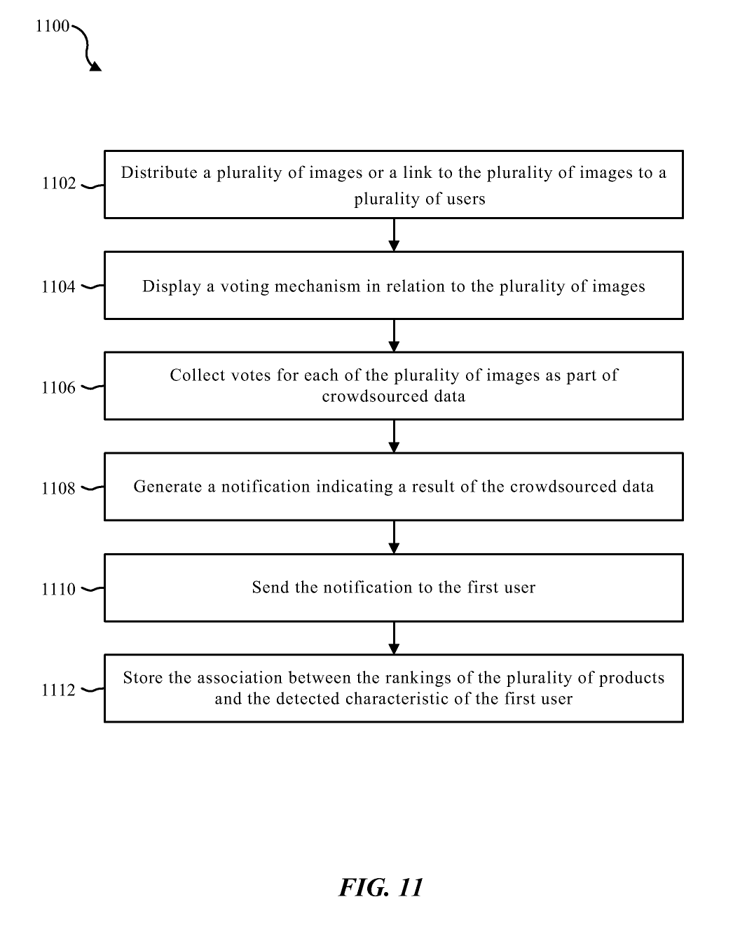

FIG. 11 is a flow diagram illustrating one embodiment of a method 1100 for notifying a user of the results of gathering crowdsourcing data. In some configurations, the method 1100 may be implemented by the crowdsourcing module 104 illustrated in FIGS. 1, 2, and/or 3. In some configurations, the method 1100 may be implemented by the application 202 illustrated in FIG. 2.

At block 1102, a plurality of images or a link to the plurality of images may be distributed to a plurality of users. At block 1104, a voting mechanism may be displayed in relation to the plurality of images. At block 1106, votes for each of the plurality of images may be collected as part of crowdsourced data. At block 1108, a notification indicating a result of the crowdsourced data may be generated. At block 1110, the notification may be sent to the first user. At block 1112, the association between the rankings of the plurality of products and the detected characteristic of the first user may be stored.

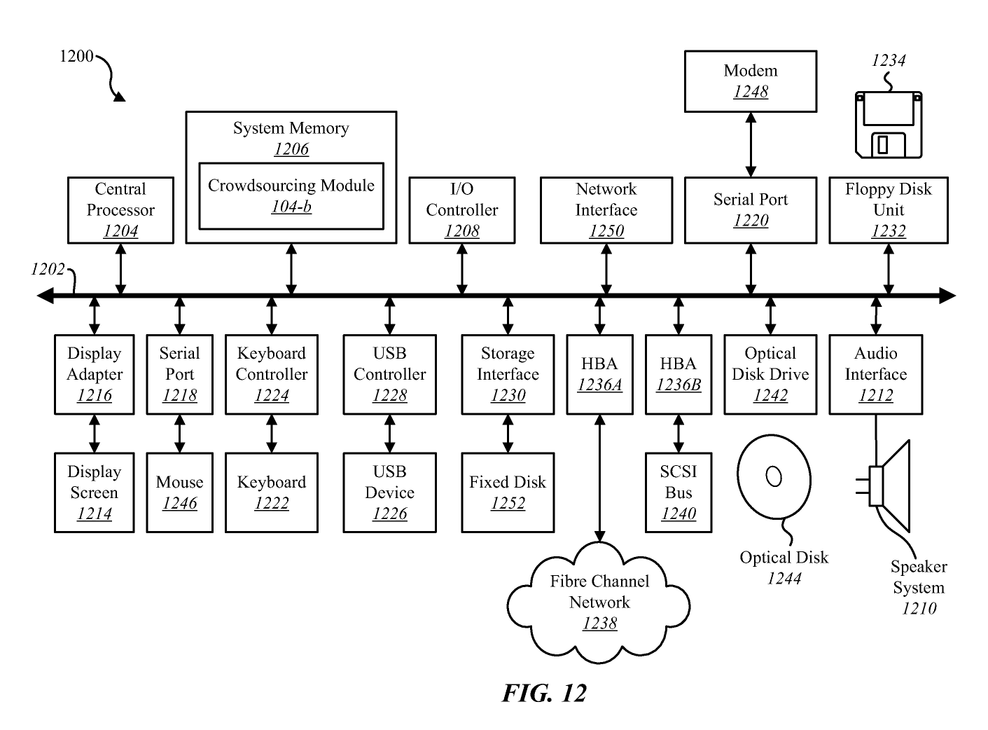

FIG. 12 depicts a block diagram of a computer system 1200 suitable for implementing the present systems and methods. The depicted computer system 1200 may be one example of a server 206 depicted in FIG. 2. Alternatively, the system 1200 may be one example of a device 102 depicted in FIGS. 1 and/or 2. Computer system 1200 includes a bus 1202 which interconnects major subsystems of computer system 1200, such as a central processor 1204, a system memory 1206 (typically RAM, but which may also include ROM, flash RAM, or the like), an input/output controller 1208, an external audio device, such as a speaker system 1210 via an audio output interface 1212, an external device, such as a display screen 1214 via display adapter 1216, serial ports 1218 and mouse 1246, a keyboard 1222 (interfaced with a keyboard controller 1224), multiple USB devices 1226 (interfaced with a USB controller 1228), a storage interface 1230, a host bus adapter (HBA) interface card 1236A operative to connect with a Fibre Channel network 1238, a host bus adapter (HBA) interface card 1236B operative to connect to a SCSI bus 1240, and an optical disk drive 1242 operative to receive an optical disk 1244. Also included are a mouse 1246 (or other point-and-click device, coupled to bus 1202 via serial port 1218), a modem 1248 (coupled to bus 1202 via serial port 1220), and a network interface 1250 (coupled directly to bus 1202).

Bus 1202 allows data communication between central processor 1204 and system memory 1206, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a crowdsourcing module 104-b to implement the present systems and methods may be stored within the system memory 1206. An operation of the crowdsourcing module 104-b may be executed by one or more processors (e.g., central processor 1204). The crowdsourcing module 104-b may be one example of the crowdsourcing module 104 depicted in FIGS. 1, 2, and/or 3. Applications resident with computer system 1200 are generally stored on and accessed via a non-transitory computer readable medium, such as a hard disk drive (e.g., fixed disk 1252), an optical drive (e.g., optical drive 1242), or other storage medium. Additionally, applications can be in the form of electronic signals modulated in accordance with the application and data communication technology when accessed via network modem 1248 or interface 1250.

Storage interface 1230, as with the other storage interfaces of computer system 1200, can connect to a standard computer readable medium for storage and/or retrieval of information, such as a fixed disk drive 1252. Fixed disk drive 1252 may be a part of computer system 1200 or may be separate and accessed through other interface systems. Modem 1248 may provide a direct connection to a remote server via a telephone link or to the Internet via an internet service provider (ISP). Network interface 1250 may provide a direct connection to a remote server via a direct network link to the Internet via a POP (point of presence). Network interface 1250 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 12 need not be present to practice the present systems and methods. The devices and subsystems can be interconnected in different ways from that shown in FIG. 12. The operation of at least some of the computer system 1200 such as that shown in FIG. 12 is readily known in the art and is not discussed in detail in this application. Code to implement the present disclosure can be stored in a non-transitory computer-readable medium such as one or more of system memory 1206, fixed disk 1252, or optical disk 1244. The operating system provided on computer system 1200 may be MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for recommending a product, the method comprising:
detecting a characteristic of a first user from an image of the first user;
ranking a plurality of products based on crowdsourced data received for a plurality of images depicting the first user in relation to the plurality of products; and
associating one or more relatively higher ranked products from the ranking of the plurality of products with the detected characteristic of the first user.

2. The method of claim 1, further comprising:
detecting a characteristic of a second user from an image of the second user.

3. The method of claim 2, further comprising:
comparing the characteristic of the first user to the characteristic of the second user; and
upon determining a match exists between the characteristics of the first and second users, recommending a product to the second user based on the association between the one or more relatively higher ranked products and the matching detected characteristic of the first user.

4. The method of claim 1, further comprising:
distributing the plurality of images or a link to the plurality of images to a plurality of users.

5. The method of claim 4, further comprising:
displaying a voting mechanism in relation to the plurality of images; and
collecting votes for each of the plurality of images as part of the crowdsourced data.

6. The method of claim 1, further comprising:
generating a list of products; and
placing the one or more relatively higher ranked products towards the top of the list.

7. The method of claim 1, further comprising:
generating a notification indicating a result of the crowdsourced data; and
sending the notification to the first user.

8. The method of claim 1, further comprising
storing the association between the rankings of the plurality of products and the detected characteristic of the first user.

9. A computing device configured to recommend products, comprising:
a processor;
memory in electronic communication with the processor;
instructions stored in the memory, the instructions being executable by the processor to:
detect a characteristic of a first user from an image of the first user;
rank a plurality of products based on crowdsourced data received for a plurality of images depicting the first user in relation to the plurality of products; and
associate one or more relatively higher ranked products from the ranking of the plurality of products with the detected characteristic of the first user.

10. The computing device of claim 9, wherein the instructions are executable by the processor to:
detect a characteristic of a second user from an image of the second user.

11. The computing device of claim 10, wherein the instructions are executable by the processor to:
compare the characteristic of the first user to the characteristic of the second user; and
upon determining a match exists between the characteristics of the first and second users, recommend a product to the second user based on the association between the one or more relatively higher ranked products and the matching detected characteristic of the first user.

12. The computing device of claim 9, wherein the instructions are executable by the processor to:
distribute the plurality of images or a link to the plurality of images to a plurality of users.

13. The computing device of claim 12, wherein the instructions are executable by the processor to:
display a voting mechanism in relation to the plurality of images; and
collect votes for each of the plurality of images as part of the crowdsourced data.

14. The computing device of claim 9, wherein the instructions are executable by the processor to:
generate a list of products; and
place the one or more relatively higher ranked products towards the top of the list.

15. The computing device of claim 9, wherein the instructions are executable by the processor to:
generate a notification indicating a result of the crowdsourced data; and
send the notification to the first user.

16. The computing device of claim 9, wherein the instructions are executable by the processor to:
store the association between the rankings of the plurality of products and the detected characteristic of the first user.

17. A computer-program product for recommending, by a processor, products, the computer-program product comprising a non-transitory computer-readable medium storing instructions thereon, the instructions being executable by the processor to:
detect a characteristic of a first user from an image of the first user;
rank a plurality of products based on crowdsourced data received for a plurality of images depicting the first user in relation to the plurality of products; and
associate one or more relatively higher ranked products from the ranking of the plurality of products with the detected characteristic of the first user.

18. The computer-program product of claim 17, wherein the instructions are executable by the processor to:
detect a characteristic of a second user from an image of the second user.

19. The computer-program product of claim 17, wherein the instructions are executable by the processor to:
compare the characteristic of the first user to the characteristic of the second user; and
upon determining a match exists between the characteristics of the first and second users, recommend a product to the second user based on the association between the one or more relatively higher ranked products and the matching detected characteristic of the first user.

20. The computer-program product of claim 19, wherein the instructions are executable by the processor to:
distribute the plurality of images or a link to the plurality of images to a plurality of users;
display a voting mechanism in relation to the plurality of images;
collect votes for each of the plurality of images as part of the crowdsourced data;
generate a notification indicating a result of the crowdsourced data; and
send the notification to the first user.
